(19) United States
(12) Patent Application Publication
(10) Pub. No.: US 2005/0224285 A1
(43) Pub. Date: Oct. 13, 2005

(54) JarCar Ladder

(76) Inventor: Arthur Lee Johnson, Baltimore, MD (US)

Correspondence Address: ARTHUR L. JOHNSON, 4928 Frankford Ave, Baltimore, MD, 21206, US

(21) Appl. No.: 10/819,794

(22) Filed: Apr. 8, 2004

(51) Int. Cl. A62B 1/06

(52) U.S. Cl. 182/70

(57) ABSTRACT

The JarCar Ladder presents an effective, safe, sure, way for people to escape buildings of all heights in emergencies by using commonplace materials (concrete, steel bar, wire cables, hooks, rope, wooden seat, etc.) in a unique life-saving manner, requiring no great intellect to use or employ. The newness of the invention is in its revelation of how minor things can work together as a complete unit for major accomplishments under the most dire circumstances when time is “of the essence.”

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The JarCar Ladder is a fire/emergency escape apparatus designed specifically to provide an emergency exit to enable individuals to safely evacuate a building from any level above ground level in the event of a fire or other emergency.

### BRIEF SUMMARY OF THE INVENTION

The JarCar Ladder is an invaluable fire/emergency escape apparatus because it allows the exiting of the tallest buildings in guaranteed safety. The twin towers disaster is probably the best example of how helpful this invention would have been in saving lives. When the buildings were hit, people in upper floors were basically confmed to the stairwell to exit the building, a near hopeless journey.

The JarCar Ladder is a portable apparatus (capable of being made larger and non-portable) and would be set up inside or outside a building structure adjacent to any window above ground level which can be used as an exit. The major component parts of the JarCar Ladder are [1] the window mounting bar, [2] the window brace, [3] the rope guide, [4] pre-drilled holes, [5] steel wire cables, [6] safety seat with back rest, [7] sturdy rope with quick release hooks on each end, [8] the base pipe, [9] steel wire cable hooks, [10] the rope ring located under the safety seat, [11a] seat hook lock, [11b] eye hook, [12] the concrete base, and [13] U-hooks.

### BRIEF DESCRIPTION OF THE SEVERAL VIEWS OF THE DRAWING

FIG. 1 depicts the JarCar Ladder set up for use from the window of a multi-story building.

FIG. 2 depicts the JarCar Ladder displayed laying down with all its component parts.

FIG. 3 depicts the separated component parts of the JarCar Ladder, numbered to correspond to the assembled JarCar Ladder shown in FIGS. 1 and 2.

FIG. 4 depicts the last two separated component parts of the JarCar Ladder, numbered to correspond to the assembled JarCar Ladder shown in FIGS. 1 and 2.

### DETAILED DESCRIPTION OF THE INVENTION

The JarCar Ladder is a fire/emergency escape apparatus designed specifically to provide an emergency exit to enable individuals to safely evacuate a building from any level above ground level in the event of a fire or other emergency.

The JarCar Ladder is a portable apparatus (capable of being made larger and non-portable) and would be set up inside or outside a building structure adjacent to any window above ground level which can be used as an exit. The major component parts of the JarCar Ladder are [1] the window mounting bar, [2] the window brace, [3] the rope guide, [4] pre-drilled holes, [5] steel wire cables, [6] safety seat with back rest, [7] sturdy rope with quick release hooks on each end, [8] the base pipe, [9] steel wire cable hooks, [10] the rope ring located under the safety seat, [11a] seat hook lock, [11b] eye hook, [12] the concrete base, and [13] U-hooks.

The window mounting bar, or pipe, would be inserted on the inside of an open window and used to anchor the upper part of the JarCar Ladder to the house. A brace is attached to each end of the window mounting bar which would be abutted against the wall. The mounting bar has a circular opening on the left and right side for the routing of the two, 30 foot lengths (or more) of wire cable. The wire cables go though pre-drilled holes on the left and right side of the seat base, functioning as a guide for ascending and descending. The lower ends of the wire cables travel through pre-drilled holes on a second steel bar which then terminates with two metal hooks. The hooks can be secured to [1] a concrete base or [2] any heavy, sturdy, solid object which is extremely difficult to move, such as a truck or car; also, the steel bar next to the hooks can be held by any strong person(s) weighing three times the weight of the escaping individual(s). The safety seat with backrest is pulled downward or upward by the sturdy rope. The upper end and bottom end of the rope is attached to an eye-ring under the safety seat. The rope is then routed through guides on the upper and bottom steel pipes.

The JarCar Ladder could be easily and quickly set up and could be an invaluable piece of equipment for any multi-story building or structure in the event of a fire or other emergency.

Generally, the JacCar Ladder would be assembled as follows: the braces (2) and the rope guide (3) would be placed on the window mounting bar (1). The steel wire cables (5) would be routed through the pre-drilled holes (4) on both sides of the window mounting bar (1). Then, they would be routed through the safety seat (6). The steel wire cables (5) would be routed through the pre-drilled holes (4) on both sides of the base pipe (8). The rope guide (3) would be placed on the base pipe (8). The steel wire cable hooks (9) are attached to the end of the steel wire cables (5) near the base pipe (8). U-Hooks (13) are attached to the steel wire cables (5) near the window mounting bar (1). The sturdy rope with quick release hooks on each end (7) is routed through the rope guide (3) on the window mounting bar (1). Then, one of the quick release hooks on the sturdy rope (7) is attached to the rope ring (10) under the safety seat (6). The other end of the sturdy rope with quick release hooks (7) is routed through the rope guide (3) on the base pipe (8). Then, the quick release hook on the sturdy rope (7) is attached to the rope ring (10) under the safety seat (6). The concrete base (12) is separate but part of The JarCar Ladder for purposes of connecting the steel wire cable hooks (9) to the eye hooks (11b) on the concrete base.

### DRAWINGS

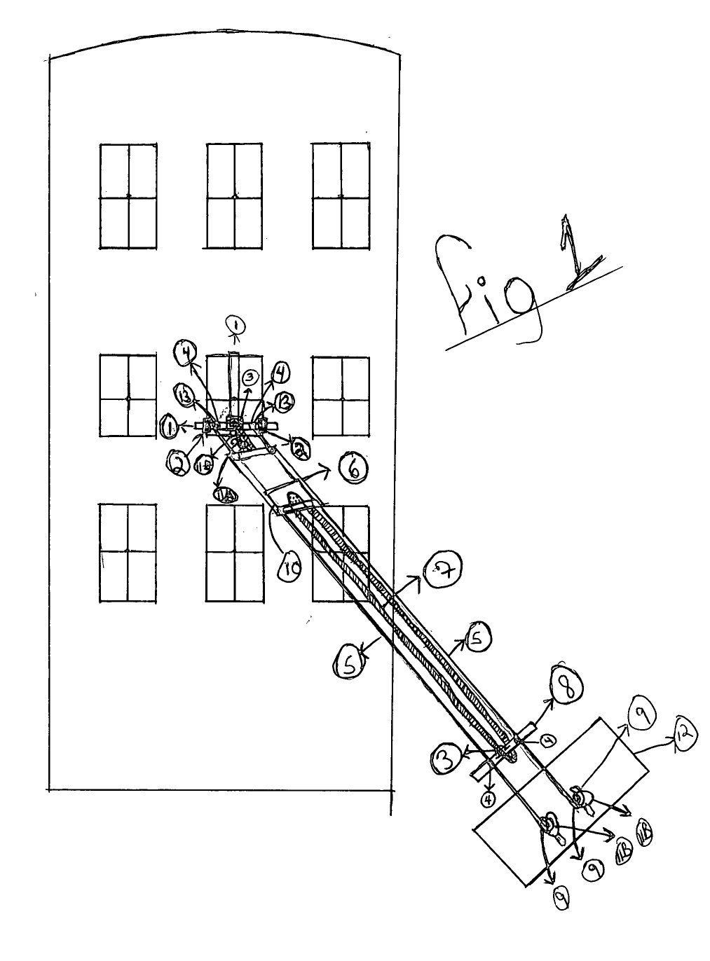

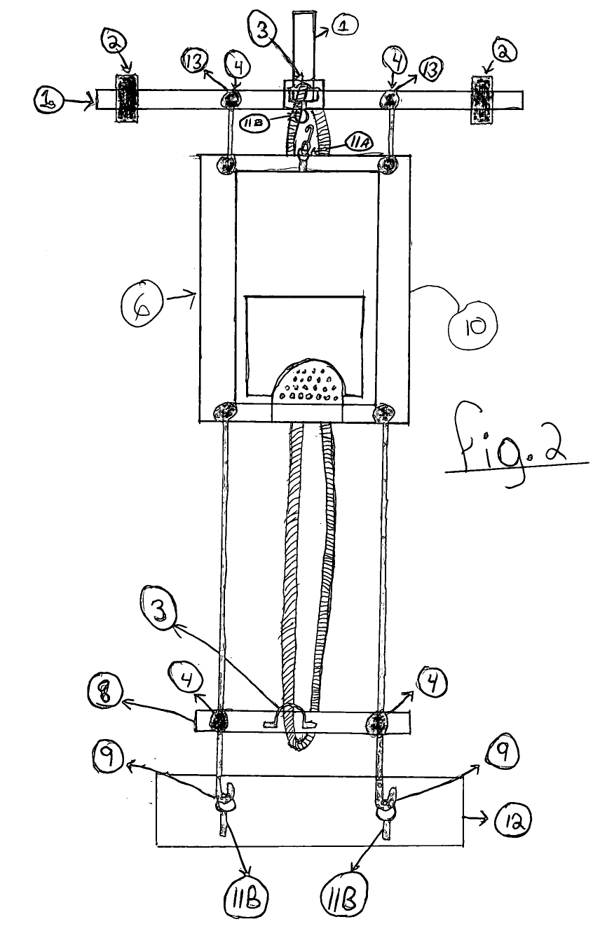

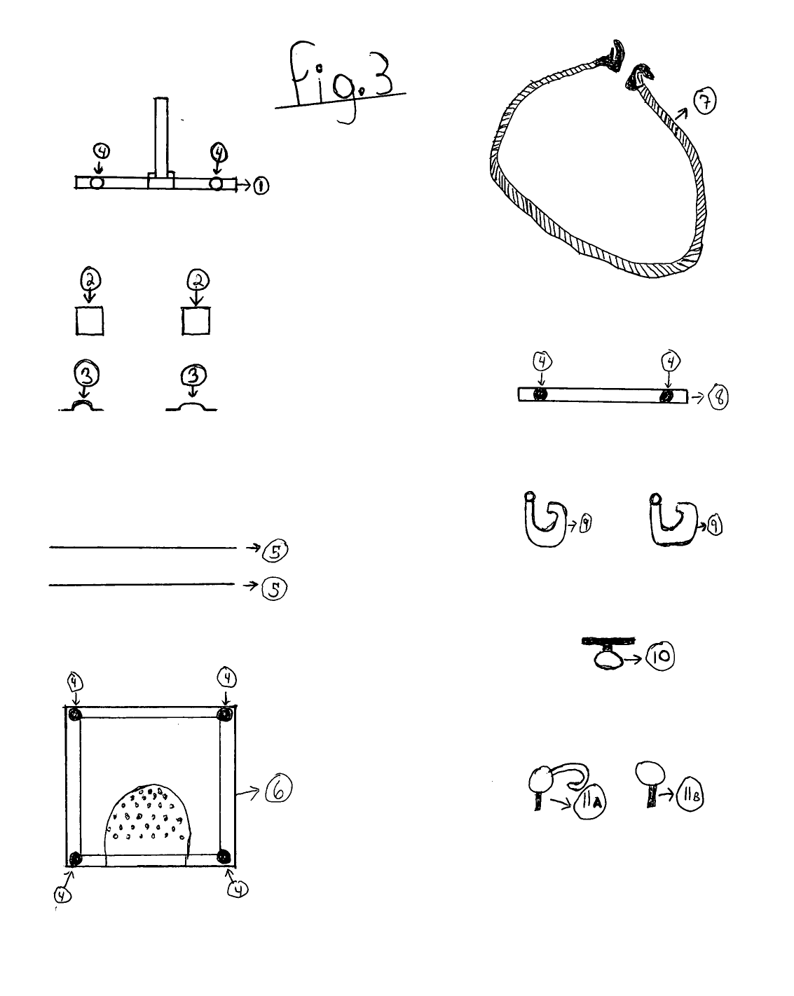

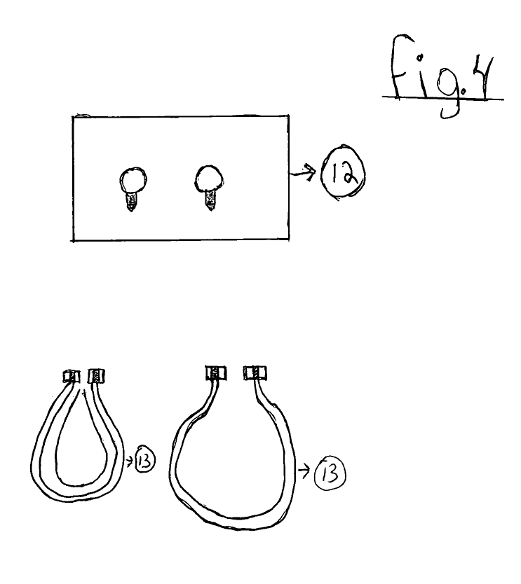

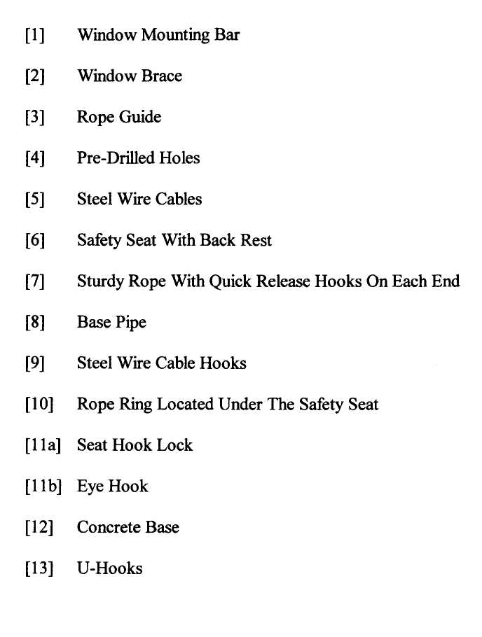

The drawing in FIG. 1 shows the JarCar Ladder connected to the window of a multi-story building with the window mounting bar (#1 of FIG. 3). The bottom of the JarCar Ladder is connected to the concrete base on the ground (#12 of FIG. 4). The safety seat (#6 of FIG. 3) is located at the top of the JarCar Ladder. The rope (#7 of FIG. 3) extends from the top to the bottom of the JarCar Ladder. It travels around both the window mounting bar (#1 of FIG. 3) and the base pipe (#8 of FIG. 3) by the rope guides (#3 of FIG. 3). One end of the rope has a quick release hook (#7 of FIG. 3) and the other end has a quick release hook (#7 of FIG. 3). The quick release hooks attach to the rope ring (#10 of FIG. 3) under the seat. On the front of the seat (#6 of FIG. 3) is the seat hook lock (#11a of FIG. 3), which is to be connected to the eye hook (#11b of FIG. 3) of the window mounting bar, preventing the seat from moving when mounting. Traveling up and down the JarCar Ladder on the right and left are the steel cables (#5 of FIG. 3), which pass through pre-drilled holes on the window mounting bar (#4 of #1 of FIG. 3), the safety seat (#4 of #6 of FIG. 3), and the base pipe (#4 of #8 of FIG. 3), with the hooks at the bottom of each cable (#9 of FIG. 3) connected to the concrete base (#12 of FIG. 4) and the U-locks at the top of each cable (#13 of FIG. 4) connected to the window mounting bar (#1 of FIG. 3).

The drawing in FIG. 2 is the JarCar Ladder laying down with its component parts displayed and numbered to correspond to FIG. 3 and FIG. 4.

The drawing in FIG. 3 shows the component parts of the JarCar Ladder, namely, [1] the window mounting bar, [2] the window brace, [3] the rope guide, [4] pre-drilled holes, [5] steel wire cables, [6] safety seat with back rest, [7] sturdy rope with quick release hooks on each end, [8] the base pipe, [9] steel wire cable hooks, [10] the rope ring located under the safety seat, [11a] seat hook lock, and [11b] eye hook.

The drawing in FIG. 4 shows the two remaining component parts of the JarCar Ladder, namely, [12] the concrete base, and [13] U-hooks.

1. What I claim as my invention is the jarcar ladder as a whole (regardless of adjustments in size, diameter, width, length, height, number of parts, size of parts, name of parts, safety seat strap/bar, safety seat arm rest, alternative earth anchor such as [for example] an auger, accessories to improve function, etc.) and its functioning. Specifically, the apparatus and how it works, including the component parts' role in such, the parts being, [1] the window mounting bar, [2] the window brace, [3] the rope guide, [4] pre-drilled holes, [5] steel wire cables, [6] safety seat with back rest, [7] sturdy rope with quick release hooks on each end, [8] the base pipe, [9] steel wire cable hooks, [10] the rope ring located under the safety seat, [1 la] seat hook lock, [11b] eye hook, [12] the concrete base, and [13] U-hooks.
